(19) United States
(12) Patent Application Publication
(10) Pub. No.: US 2007/0251114 A1
(43) Pub. Date: Nov. 1, 2007

(54) Dryer

(75) Inventor: Kyung Tae Kim, Gimhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 11/785,259

(22) Filed: Apr. 16, 2007

(30) Foreign Application Priority Data
Apr. 17, 2006 (KR) 2006-0034728

(51) Int. Cl. F26B 21/06; F26B 19/00

(52) U.S. Cl. 34/82; 34/85

(57) ABSTRACT

The present invention relates to a dryer, which can prevent foreign substances from passing in a heater case accommodating a heater and prevent damage to fabric as well as accidents. The dryer includes a drum that forms predetermined space for drying laundry; a heater case in which a heater for supplying hot air to the drum is provided; and a filtering device that prevents foreign substances from being drawn into the heater case.

### CROSS REFERENCE TO RELATED APPLICATION

This application claims the benefit of Korean Patent Application No. 10-2006-0034728, filed on Apr. 17, 2006, which is hereby incorporated by reference as if fully set forth herein.

### BACKGROUND OF THE DISCLOSURE

1. Field of the Disclosure

The present invention relates to a dryer. More particularly, the present invention relates to a dryer, which can prevent foreign substances from passing in a heater case accommodating a heater and prevent damage to fabric as well as accidents.

2. Discussion of the Related Art

Generally, dryers are home appliances that are used to dry clothes, cloth item and beddings (hereinafter, laundry) that are wet. There are dryers having only a drying function and laundry machines having a drying and washing function. The dryers are typically categorized into an air exhaustion-type dryer and an air condensation-type dryer based on a drying method. In the exhaustion-type dryer, external air is supplied to dry laundry. In the air condensation-type dryer, internal air is circulated to dry laundry and moisture is removed. The moisture is condensed into water and the water is discharged.

Such dryer includes a drum in which laundry is dried and a heater case which accommodates a heater for supplying hot air into the drum. The laundry loaded into the drum is dried by the hot air supplied by the heater.

However, if foreign substances are drawn into the heater case during the drying in such conventional dryers, the foreign substances might be burned by the heater and thus there might be danger of fires. Also, if the burnt foreign substances are drawn into the drum and contacted with the fabric, there might be damage to laundry.

### SUMMARY OF THE DISCLOSURE

Accordingly, the present invention is directed a dryer.

An object of the present invention is to provide a dryer which can prevent foreign substances from being drawn into a heater case to prevent possibility of accidents.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dryer includes a drum that forms predetermined space for drying laundry; a heater case in which a heater for supplying hot air to the drum is provided; and a filtering device that prevents foreign substances from being drawn into the heater case.

The filtering device prevents foreign substances inside the drum from being drawn into the heater case. That is, it is preferred that the filtering device is provided at a predetermined portion in which the drum and the heater case are connected.

The heater case includes an air inlet through which air is drawn; and an air outlet through which the air drawn through the air inlet is heated by the heater and the air is exhausted into the drum. It is preferred that the filtering device is provided at the air outlet.

The filtering device includes a frame part that defines a rim of the filtering device; and a filter formed in the frame part to prevent foreign substances there through. It is preferred that the filter may be an expanded metal. Also, it is preferred that the size of each air gap formed at the expanded metal may be 4 mm*8 mm, and 4 mm is a short diameter and 8 mm is a long diameter. The expanded metal may be fabricated with one of steel sheet, aluminum sheet, stainless steel sheet and shell plate which is heat-resistant.

The dryer further includes a securing part that secures the filtering device to the heater case. The securing part may include a bending part projected from a predetermined portion of the frame part, and a fastening part formed at the heater case to which the bending part is secured.

It is preferred that the bending part is formed of a plurality of bending protrusions which are bendable and the fastening part is formed of a plurality of grooves or holes to which the bending protrusions are secured.

The securing part may further include a separation preventing part that prevents the filtering device from separating from the heater case.

The separation preventing part may include at least one engaging protrusion projected at either of a predetermined portion of an air outlet and a predetermined portion of the frame part, and an engaging hole formed at the other of the predetermined portion of the air outlet and the predetermined portion of the frame part. The engaging hole is corresponding to the engaging protrusion.

The bending part may include a first bending part projected at an upper surface of the frame part and a second bending part projected at a lower surface of the frame part, and the fastening part comprises a first fastening part to which the first bending part is fastened and a second fastening part to which the second bending part is fastened.

The first bending part and the second bending part may be bending protrusions that are bendable, and either of the first fastening part and the second fastening part may be an inserting hole in which the bending protrusion is inserted and the other may be a seating groove in which the bending protrusion is seated. It is preferred that the first fastening part is a seating groove and the second fastening part is an inserting hole.

The securing part may further include a separation preventing part that prevents an upper portion of the filtering device from separating from the heater case.

The separation preventing part may include at least one engaging protrusion projected at either of an upper surface of the frame part and an upper surface of the air outlet, and at least one engaging groove formed at the other of the upper surface of the frame part and an upper surface of the air outlet.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a longitudinal sectional view illustrating an exhaustion-type dryer according to an embodiment;

FIG. 2 is a perspective view illustrating that a filtering device is installed in a heater case according to the embodiment;

FIG. 3 is an exploded perspective view illustrating the filtering device and the heater case according to the embodiment;

FIG. 4 is a sectional view illustrating I-I line shown in FIG. 2; and

FIG. 5 is a diagram illustrating that a first bending protrusion according to the embodiment is fastened.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

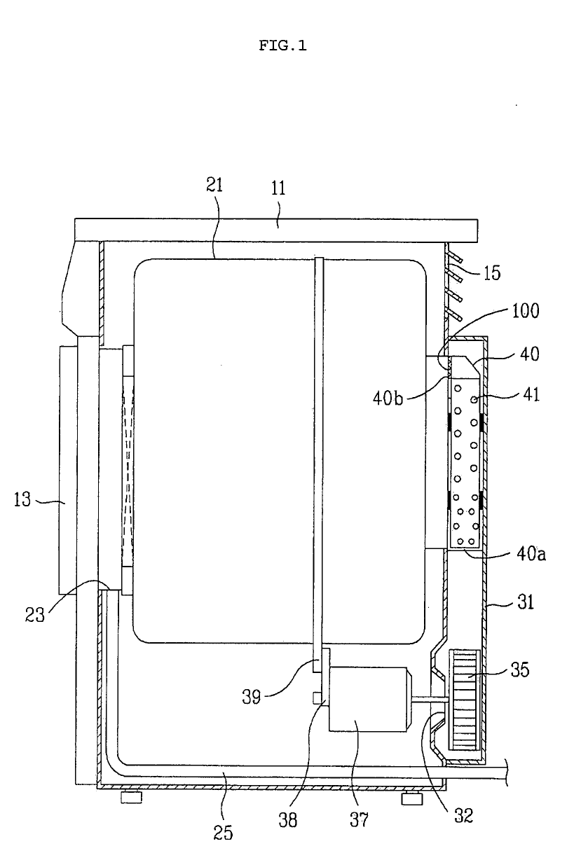

FIG. 1 is a longitudinal sectional view illustrating an exhaustion-type dryer according to an embodiment.

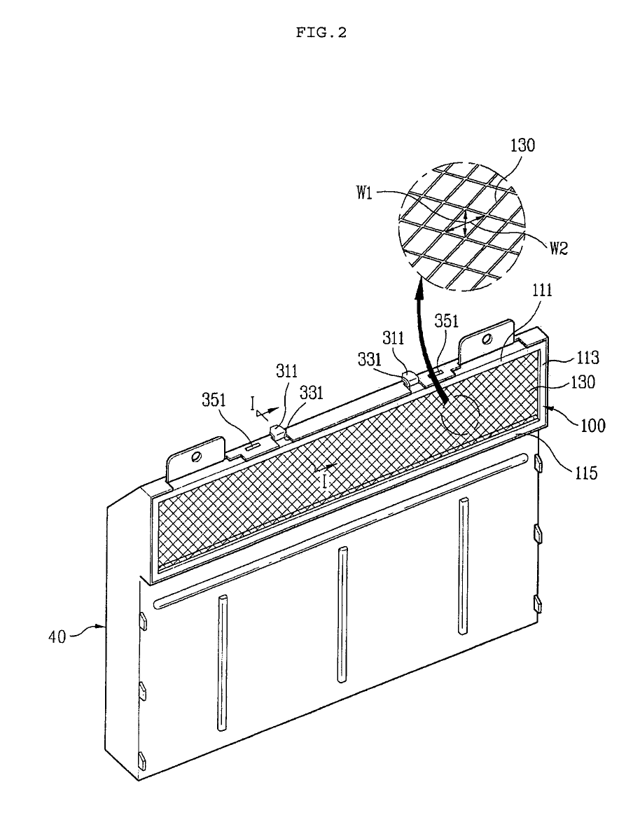

FIG. 2 is a perspective view illustrating that a filtering device is installed in a heater case according to the embodiment.

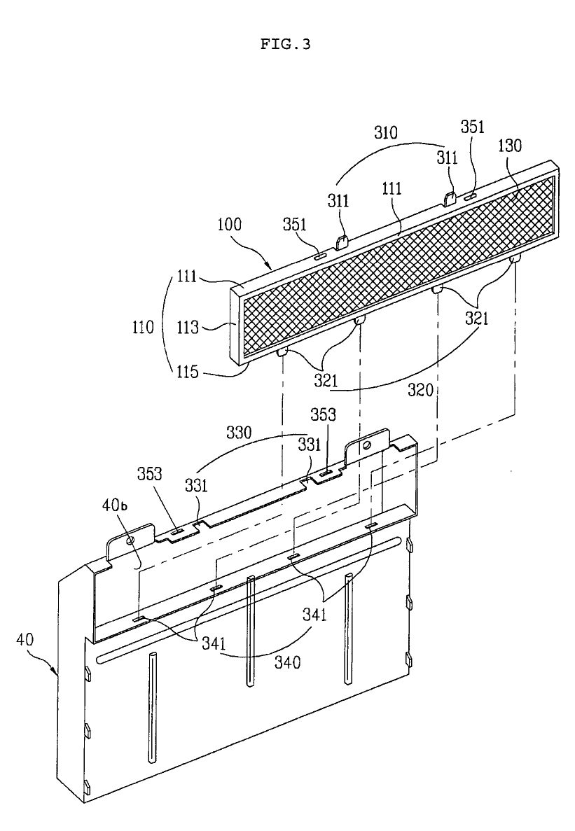

FIG. 3 is an exploded perspective view illustrating the filtering device and the heater case according to the embodiment.

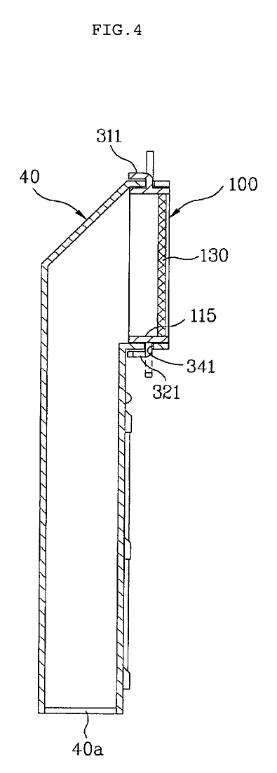

FIG. 4 is a sectional view I-I of line shown in FIG. 2 illustrating that a second bending protrusion is fastened.

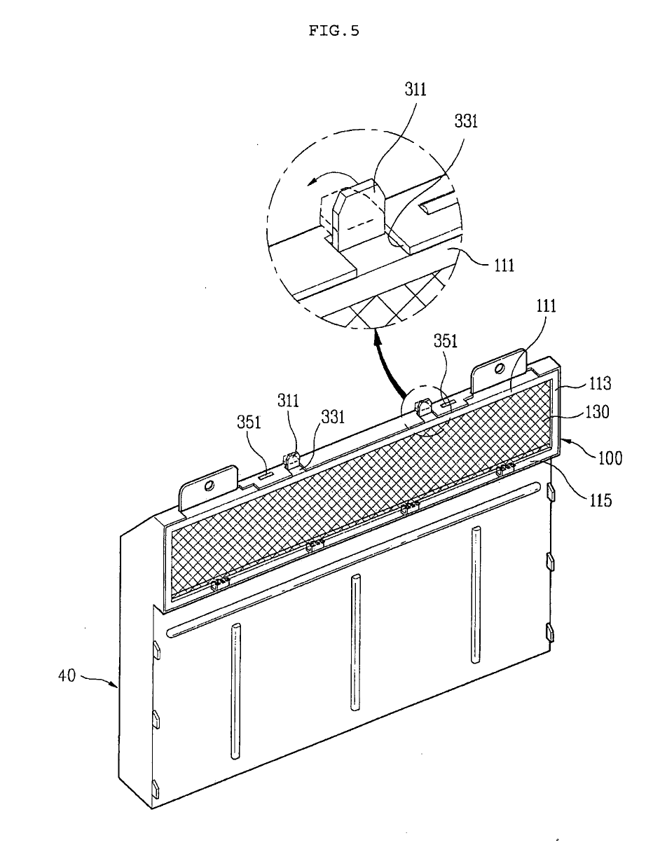

FIG. 5 is a diagram illustrating that a first bending protrusion according to the embodiment is fastened.

In reference to FIGS. 1 and 2, a dryer according to the embodiment includes a drum 21, a heater case 40, a filtering device 100 and a securing part. The drum 21 is rotatable within a case 11 and it forms predetermined space for drying laundry. The heater case 40 is connected to a rear portion of the drum 21 and a heater 41 is provided within the heater case 40. The filtering device 100 is provided at a predetermined portion where the drum 21 and the heater case 40 are connected and it prevents foreign substances from being drawn into the heater case 40. The securing part secures the filtering device 100 to the heater case 40.

The dryer according to the embodiment may further include an air suction duct 31, an air suction fan 35 and a driving part. The air suction duct 31 is provided in rear of the drum 21, and it sucks air and supplies the air to the drum 21. The air suction fan 35 is rotatable in the air suction duct 31. The driving part is mounted in a predetermined potion under the drum 21 to drive the drum 21 and the air suction fan 35. Here, an air suction hole 32 through which air is sucked into the air suction duck 31 may be formed at a lower portion of the air suction duct 31.

The driving part includes a motor 37, a pulley 38 and a belt 39. The motor 37 rotates the air suction fan 35 and the drum 21. The pulley 38 is provided in a predetermined portion of the motor 37. The belt 39 is connected to a circumferential surface of the drum 20 to transmit a rotational force to the drum 20.

Moreover, a door 13 is coupled to a front of the cabinet 11 through which the laundry is loaded and unloaded. An inlet 15 is formed in a rear surface of the cabinet 11 through which air is drawn inside the cabinet 11.

An outlet 23 and an air exhaustion duct 25 may be provided in a front portion of the drum 21 through which the air inside the drum 21 is exhausted.

The filtering device 100 according to the embodiment is provided to prevent foreign substances from being drawn into the heater case 40. Relatively large foreign substances, for example, a lump of lint that is produced inside the drum 21 during the drying may be drawn into the heater case 40. Accordingly, it is preferred to provide the filtering device 100 for preventing foreign substances inside the drum 21 from being drawn into the heater case 40. For that, the filtering device 100 may be provided at a predetermined portion where the drum 21 and the heater case 40 are connected.

The heater case 40 may be provided inside the air suction duct 31 and it may have an air inlet 40a through which air is drawn and an air outlet 40b through which hot air is exhausted. In this case, it is preferred that the filtering device 100 is provided at the air outlet 40b of the heater case 40 to prevent relatively large foreign substances, for example, a lump of lint from being drawn into the heater case 40.

The filtering device 100 according to the embodiment will be now explained in detail.

In reference to FIGS. 3 and 4, the filtering device 100 according to the embodiment includes a frame part 110 and a filter 130 formed in the frame part 110.

The frame part 110 includes an upper frame 111 that defines an upper rim of the filtering device 100, a side frame 113 that defines both opposite side rims of the filtering device 100, and a lower frame 115 that defines a lower rim of the filtering device 100. Each frame has a flange that is bent inward and inserted in the air outlet 40b of the heater case 40.

It is preferred that the filter 130 is an expanded metal.

On the other hand, the filter 130 may be also formed in a woven wire cloth structure. In the woven wire cloth structure, wires are crossed in a vertical and horizontal direction and each crossed spot is spot-welded. Thus, the manufacturing process is complicated, and dirt and foreign substances may be stuck on a portion where each wire is crossed.

However, the net of the expanded metal is fabricated as one body by a single process and a surface of the net is plane by pressing. As a result, it is possible for the filtering device 100 to have a simple structure and foreign substances may be prevented from being stuck on the filtering device 100.

The size of each air gap formed at the expanded metal is 4 mm*8 mm. More specifically, 4 mm is a short diameter (W1) of the air gap and 8 mm is a long diameter (W2) of the air gap, as shown in FIG. 2.

The above size is determined in order to prevent relatively large foreign substances produced inside the drum 21 from passing each air gap together with minimizing the reduction of hot air that passes the heater case 40 and the drum 21.

By the way, the expanded metal may be fabricated with one of steel sheet, aluminum plate, stainless steel sheet and shell plate. This embodiment presents that the expanded metal is fabricated with stainless steel to prevent deformation of the filter 130 caused by hot air that is supplied to the drum 21 from the heater case 40.

The securing part will be now explained in detail according to the embodiment.

The securing part secures the filtering device 100 to the heater case 40 and it includes a first bending part 310, a second bending part 320, a first fastening part 330 and a second fastening part 340. The first and second bending part 310 and 320 are projected at an upper and lower surface of the frame part 110, respectively. The first and second fastening part 330 and 340 are formed at an upper and lower surface of the air outlet 40b, respectively. The first bending part 310 is fastened to the first fastening part 330 and the second bending part 320 is fastened to the second fastening part 340. The first and second fastening part 330 and 340 may be grooves or holes.

Preferably, the first bending part 310 may be formed of a plurality of first bending protrusions 311. The first fastening part 330 may be formed of a plurality of seating grooves 331 on which the first bending protrusions 311 are seated to be bendable. The second bending part 320 may be formed of a plurality of second bending protrusions 321 and the second fastening part 340 may be formed of a plurality of inserting holes 341 in which the second bending protrusions 321 are inserted to be bendable in a predetermined direction.

As mentioned above, when the first fastening part 330 is seating grooves 331 and the second fastening part 340 is inserting holes 341, it is simple to secure the filtering device 100 to the heater case 40.

This is because the second bending part 330 formed in the lower surface of the frame part 110 is inserted in the second fastening part 340 that is the inserting hole 341, and thus the first bending part 330 formed in the upper surface of the frame part 110 is seated on the first fastening part 330 that is the seating groove 330, which is an easy securing structure.

Of course, alternatively, the first fastening part 330 may be formed of inserting holes and the second fastening part 340 may be formed of seating grooves. More specifically, either of the first fastening part 330 and the second fastening part 340 may be formed of the inserting holes and the other may be formed of the seating grooves. However, as mentioned above, it is preferred that the first fastening part 330 formed on the upper surface of the frame part 110 is the seating grooves and the second fastening part 340 formed on the lower surface of the frame part 110 is the inserting holes.

It is presented in this embodiment that two first bending protrusions 311 and two seating grooves 331 are provided. Also, it is presented in this embodiment that four second bending protrusions 321 and four inserting holes 341 are provided.

On the other hand, the securing part may further include a separation preventing part that prevents an upper portion of the filtering device 100 from separating from the heater case 40.

The separation preventing part includes at least one engaging protrusion 351 and an engaging hole 353. The engaging protrusion 351 is projected at either of an upper surface of the frame part 110 and an upper surface of the air outlet 40a. The engaging hole 353 is formed at the other of the upper surface of the frame part 110 and the upper surface of the air outlet 40a, and thus the engaging protrusions 351 are engaged to the engaging holes 353, respectively.

In this embodiment, it is presented that two engaging protrusions are formed on the upper frame 111 and two engaging holes 353 are formed on the upper portion of the air outlet 40a.

An assembly process and an operation of the filtering device described above will be now explained.

As shown in FIG. 3, four second bending protrusions 331 formed at the lower frame 115 of the filtering device 100 are inserted in four inserting holes 341 formed on the lower portion of the air outlet 40a, respectively.

Hence, as shown in FIG. 4, each second bending protrusion 331 inserted in the corresponding inserting hole 341 is bent in a predetermined direction, such that a bottom of the filtering device 100 is secured to the lower portion of the air outlet 40a.

Hence, as shown in FIG. 5, two first bending protrusions 311 formed at the upper frame 111 are seated on the seating grooves 331 formed on the upper portion of the air outlet 40a, respectively.

After that, each first bending protrusion 311 seated on the corresponding seating groove 331 is bent, such that the top of the filtering device 100 is secured to the upper portion of the air outlet 40a.

Also, when two engaging protrusions 351 formed at the upper frame 111 are engaged to the engaging holes 353 formed at the upper portion of the air outlet 40a, the top of the filtering device 100 is prevented from separating from the heater case 40.

Thereby, the process that the filtering device 100 is secured to the air outlet 40a of the heater case 40 is complete.

As described above, the dryer according to the present invention is provided with the filtering device 100 installed at the portion where the drum 21 and the heater case 40 are connected. As a result, relatively large foreign substances are prevented from passing in the heater case 40.

Accordingly, accidents caused by combustion of foreign substances inside the heater case 40 may be prevented.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

Therefore, the above dryer has following advantages.

First, relatively large foreign substances may not be drawn into the heater case, because the filtering device is provided between the drum and the heater case.

As a result, it is prevented that the laundry is damaged by combustion of the foreign substances, still more accidents may be prevented.

Furthermore, foreign substances may not be stuck on the filter and the structure is simple and easy to fabricate, because the filter according to the present invention is the expanded metal.

A still further, it is easy to assemble the filtering device according to the present invention and it takes less time to assemble the filtering device, because the filtering device is secured by bending.

What is claimed is:

1. A dryer comprising:
a drum that forms predetermined space for drying laundry;
a heater case in which a heater for supplying hot air to the drum is provided; and
a filtering device that prevents foreign substances from being drawn into the heater case.

2. The dryer as claimed in claim 1, wherein the filtering device prevents foreign substances inside the drum from being drawn into the heater case.

3. The dryer as claimed in claim 2, wherein the filtering device is provided at a predetermined portion in which the drum and the heater case are connected.

4. The dryer as claimed in claim 1, wherein the heater case comprises,
an air inlet through which air is drawn; and
an air outlet through which the air drawn through the air inlet is heated by the heater and the air is exhausted into the drum.

5. The dryer as claimed in claim 4, wherein the filtering device is provided at the air outlet.

6. The dryer as claimed in claim 5, wherein the filtering device comprises,
a frame part that defines a rim of the filtering device; and
a filter formed in the frame part to prevent foreign substances there through.

7. The dryer as claimed in claim 6, wherein the filter is an expanded metal.

8. The dryer as claimed in claim 7, wherein the size of each air gap formed at the expanded metal is 4 mm*8 mm, and 4 mm is a short diameter and 8 mm is a long diameter.

9. The dryer as claimed in claim 7, wherein the expanded metal is fabricated with one of steel sheet, aluminum sheet, stainless steel sheet and shell plate which is heat-resistant.

10. The dryer as claimed in claim 6, further comprising:
a securing part that secures the filtering device to the heater case, wherein the securing part comprises,
a bending part projected from a predetermined portion of the frame part, and
a fastening part formed at the heater case to which the bending part is secured.

11. The dryer as claimed in claim 10, wherein the bending part is formed of a plurality of bending protrusions which are bendable and the fastening part is formed of a plurality of grooves or holes to which the bending protrusions are secured.

12. The dryer as claimed in claim 10, wherein the securing part further comprises a separation preventing part that prevents the filtering device from separating from the heater case.

13. The dryer as claimed in claim 12, wherein the separation preventing part comprises,
at least one engaging protrusion projected at either of a predetermined portion of an air outlet and a predetermined portion of the frame part, and
an engaging hole formed at the other of the predetermined portion of the air outlet and the predetermined portion of the frame part, wherein the engaging hole is corresponding to the engaging protrusion.

14. The dryer as claimed in claim 10, wherein the bending part comprises a first bending part projected at an upper surface of the frame part and a second bending part projected at a lower surface of the frame part, and the fastening part comprises a first fastening part to which the first bending part is fastened and a second fastening part to which the second bending part is fastened.

15. The dryer as claimed in claim 14, wherein the first bending part and the second bending part are bending protrusions that are bendable, and either of the first fastening part and the second fastening part is an inserting hole in which the bending protrusion is inserted and the other is a seating groove in which the bending protrusion is seated.

16. The dryer as claimed in claim 15, wherein the first fastening part is a seating groove and the second fastening part is an inserting hole.

17. The dryer as claimed in claim 16, wherein the securing part further comprises a separation preventing part that prevents an upper portion of the filtering device from separating from the heater case.

18. The dryer as claimed in claim 17, wherein the seperation preventing part comprises,
at least one engaging protrusion projected at either of an upper surface of the frame part and an upper surface of the air outlet, and
at least one engaging groove formed at the other of the upper surface of the frame part and an upper surface of the air outlet.
